(19) United States
(12) Patent Application Publication
(10) Pub. No.: US 2005/0110940 A1
(43) Pub. Date: May 26, 2005

(54) Method of manufacturing panel for liquid crystal display by division exposure

(75) Inventors: Ki-Hung Lee, Suwon-si (KR); Il-Gon Kim, Suwon-si (KR); Sung-Jae Moon, Seoul (KR); Chong-Chul Chai, Seoul (KR)

Correspondence Address: MacPherson Kwok Chen & Heid LLP, Suite 226, 1762 Technology Drive, San Jose, CA, 95110, US

(73) Assignee: SAMSUNG ELECTRONICS CO., LTD., Suwon-si (KR)

(21) Appl. No.: 10/799,438

(22) Filed: Mar. 12, 2004

(30) Foreign Application Priority Data
Mar. 13, 2003 (KR) 2003-15755

(51) Int. Cl. G02F 1/13

(52) U.S. Cl. 349/187

(57) ABSTRACT

A method of manufacturing a liquid crystal display panel by a divisional exposure with a plurality of shots including first and second shots adjacent to each other is provided, which includes: preparing a stitch area which is an overlapping area of the first and the second shots at a boundary between the first shot and the second shot and includes a plurality of unit areas, each unit area being light-exposed or light-blocked in the first and the second shots; and determining the positions or the sizes of the light-exposed unit areas or the light-blocked unit areas by a random number generator, the number of the light-exposed unit areas or the light-blocked unit areas gradually decreasing or increasing along a direction from the first shot to the second shot.

### BACKGROUND OF THE INVENTION

(a) Field of the Invention

The present invention relates to a method of manufacturing a liquid crystal display, and in particular, to a method of manufacturing an LCD panel by divisional exposure.

(b) Description of Related Art

Generally, for an LCD panel having an active area larger than the size of an exposure mask, divisional exposure dividing the active area and performing step-and-repeat process is required for forming patterns in the active area. That is, the active area is required to be exposed using at least two “shots.” In practice, since the shots are subject to shift, rotation and distortion, the shots are misaligned (referred to as “stitch error” hereinafter) to generate the difference between the shots in parasitic capacitances generated between wires and pixel electrodes and in the locations of the patterns.

The difference in parasitic capacitances and in the locations of the patterns results in the difference in electric characteristics and in the cutout ratios between the shots of the LCD panel, thereby causing the difference in the brightness between the shots to appear at the boundary between the shots.

FIG. 1 is a plan view showing the boundary between shots of a conventional LCD panel.

As shown in FIG. 1, the brightness difference in adjacent shots A and B due to the stitch error is predominant at the boundary between the shots and appears as a stripe.

For reducing the brightness difference, a conventional method of manufacturing an LCD makes the shot boundary have a saw shape. Although the brightness difference between the shots is one-step reduced at the boundary area between the shots as shown, the stripe is still visible by the human eyes. Moreover, a mosaic pattern may be observed when a unit stitch area is large.

### SUMMARY OF THE INVENTION

A method of manufacturing a liquid crystal display panel by a divisional exposure with a plurality of shots including first and second shots adjacent to each other is provided, which includes comprising: preparing a stitch area which is an overlapping area of the first and the second shots at a boundary between the first shot and the second shot and includes a plurality of unit areas, each unit area being light-exposed or light-blocked in the first and the second shots; and determining the positions or the sizes of the light-exposed unit areas or the light-blocked unit areas by a random number generator, the number of the light-exposed unit areas or the light-blocked unit areas gradually decreasing or increasing along a direction from the first shot to the second shot.

The determination may include: determining a pitch of the unit areas; determining the stitch area including a plurality of unit areas arranged in an N×M matrix; determining a moving direction of the first and the second shots; determining the number of the light-exposed unit areas or the light-blocked unit areas in each row or in each column for the first and the second shots; and determining positions of the light-exposed unit areas or the light-blocked unit areas in each row or in each column for the first and the second shots using the random number generator.

N/M or M/N is preferably a natural number.

The unit area may include a pixel area, a plurality of pixel areas, or a portion of a pixel area.

When the unit area includes a portion of a pixel area, the pixel area may be provided with a domain defining member disposed between adjacent unit areas.

The pixel area may be defined by intersections of two adjacent gate lines and two adjacent data lines and a boundary line between adjacent unit areas extends parallel to the gate lines.

### BRIEF DESCRIPTION OF THE DRAWINGS

FIG. 1 is a plan view showing two adjacent shots of a conventional LCD;

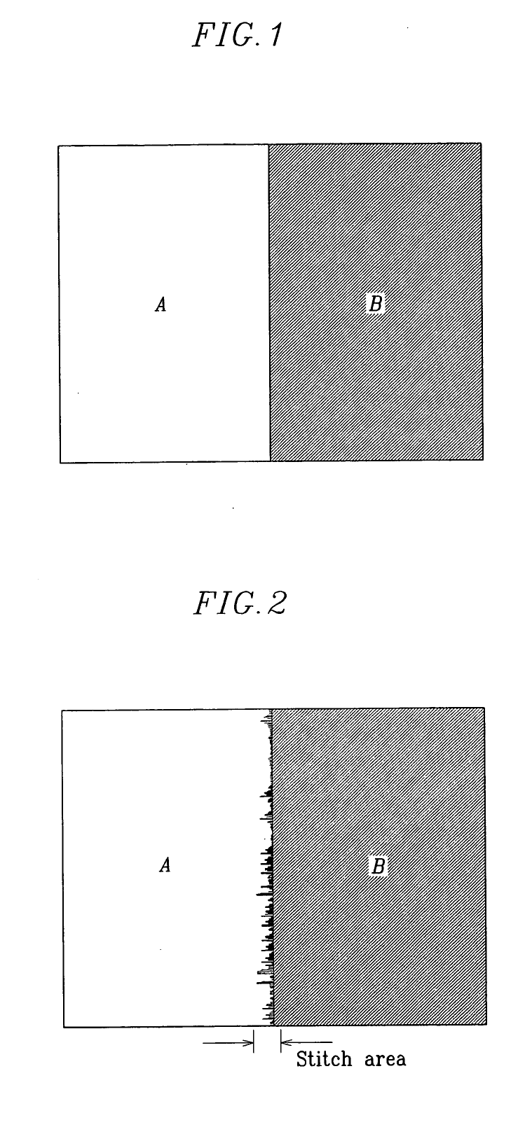

FIG. 2 is a plan view showing adjacent shots of an LCD according to an embodiment of the present invention;

FIGS. 3A and 3B are plan views showing a stitch area between shots of an LCD according to an embodiment of the present invention;

FIG. 4 is a plan view showing a unit stitch area of an LCD according to an embodiment of the present invention; and

FIG. 5 is a flow chart illustrating a method of determining the number of the unit stitch areas and the positions of the light-exposed unit stitch areas and the light-blocked unit stitch areas according to an embodiment of the present invention.

### DETAILED DESCRIPTION OF EMBODIMENTS

The present invention now will be described more fully hereinafter with reference to the accompanying drawings, in which embodiments of the invention are shown. The present invention may, however, be embodied in many different forms and should not be construed as limited to the embodiments set forth herein.

In the drawings, the thickness of layers, films and regions are exaggerated for clarity. Like numerals refer to like elements throughout. It will be understood that when an element such as a layer, film, region or substrate is referred to as being “on” another element, it can be directly on the other element or intervening elements may also be present. In contrast, when an element is referred to as being “directly on” another element, there are no intervening elements present.

Then, liquid crystal displays according to embodiments of the present invention will be described with reference to accompanying drawings.

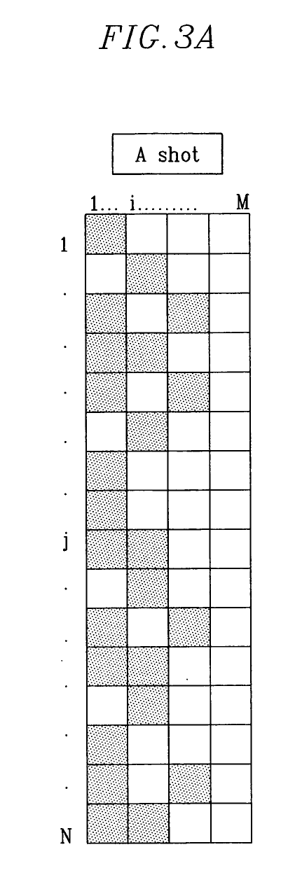

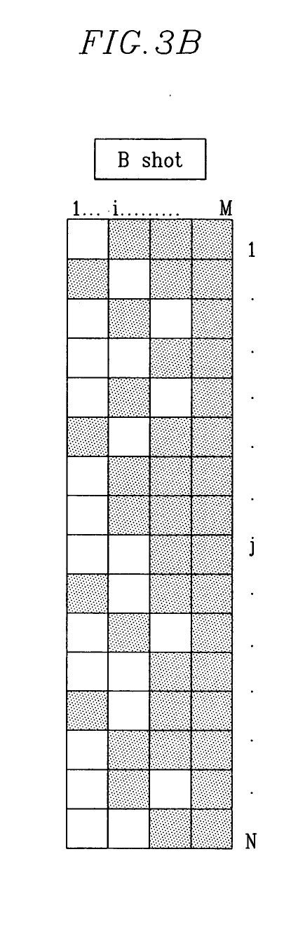

FIG. 2 is a plan view showing a stitch area between adjacent shots of an LCD panel according to an embodiment of the present invention, and FIGS. 3A and 3B are plan views showing a stitch area which is a boundary area between shots of an LCD according to an embodiment of the present invention.

The LCD panel according to an embodiment of the present invention is manufactured by photolithography using an exposure mask. When the size of an active area of the panel is larger than the size of the exposure mask, the active area is subject to a divisional exposure with step and repeat process. The active area is exposed by a plurality of shots.

Referring to FIG. 2, a stitch area, which is an overlapping area between two adjacent shots such as a left shot A (represented as a white area) and a right shot B (represented as a black area), is configured in a divisional exposure for a photoresist (not shown). In the stitch area, light-blocked areas or light-exposed areas in the left shot A do not overlap those in the right shot B. The stitch area is divided into a plurality of unit stitch areas, each of which form a light-blocked area or a light-exposed area, and the light-blocked areas and the light-exposed areas are exchanged in the shots A and B. For example, the stitch area may be divided into a plurality of unit stitch areas arranged in an N×M (where M and N are natural numbers) matrix as shown in FIGS. 3A and 3B.

FIGS. 3A and 3B illustrates arrangements of the light-blocked areas and the light-exposed areas in the left shot A and in the right shot B, respectively. The white areas represent the light-exposed areas, while the black areas represent the light-blocked areas.

As shown in FIGS. 3A and 3B, a righter column includes more light-exposed areas in the left shot A, while it includes less light-exposed areas in the right shot B.

A pixel area may include one or more unit stitch areas or a unit stitch area includes a plurality of pixel areas. The reduced size of the unit stitch area may be more effective for preventing a mosaic pattern from being recognized.

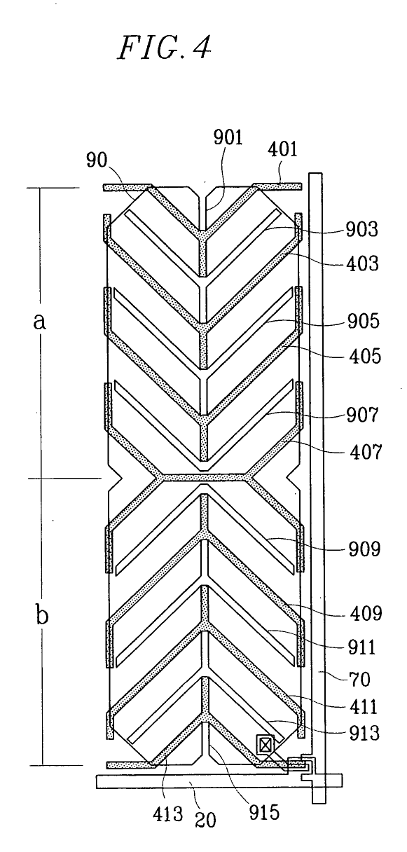

FIG. 4 is a layout view of a pixel area of an LCD according to an embodiment of the present invention. Referring to FIG. 4, a pixel area is divided into two areas a and b used as unit stitch areas.

As shown in FIG. 4, a pixel area on a thin film transistor (“TFT”) array panel is defined by intersections of a plurality of gate lines 20 extending in a transverse direction and a plurality of data lines 70 extending in a longitudinal direction. A TFT and a pixel electrode 90 having a plurality of cutouts 901, 903, 905, 907, 909, 911, 913 and 915 are provided in each pixel area. A common electrode (not shown) having a plurality of cutouts 401, 403, 405, 407, 409, 411 and 413 is formed on a color filter panel (not shown) opposite the TFT array panel. The cutouts 401, 403, 405, 407, 411, and 413 on the common electrode are hatched. The cutouts 901, 903, 905, 907, 909, 911, 913 and 915 of the pixel electrode 90 and the cutouts 401, 403, 405, 407, 411 and 413 of the common electrode are arranged in turns and partition the pixel area into a plurality of subareas. In this case, a boundary between the areas a and b is defined by a cutout 407 of the common electrode.

According to an embodiment of the present invention, each of the two areas a and b forming a pixel area is used as a unit stitch area, and the area a is exposed by shot A while the area b is exposed by shot B. In this way, since the brightness difference is much diluted compared with that for a case that a unit stitch area includes a pixel area, the stains such as a mosaic pattern is prevented. In addition, the cutout 407 disposed at the boundary between the unit stitch areas blocks a boundary line between shots which may appear even dimly due to the brightness difference between the unit stitch areas.

A method of manufacturing an LCD panel for reducing stitch errors in accordance with an embodiment of the present invention will be described with reference to FIGS. 3A and 3B.

According to this embodiment of the present invention, the number of unit stitch areas to be light-exposed for shot A in a stitch area gradually decreases and the number of unit stitch areas to be light-exposed for shot B in a stitch area gradually increases as goes to the right along the row direction, thereby making the brightness in the stitch area continuously change.

According to an embodiment of the present invention, the number of the unit stitch areas and the positions of the light-exposed unit stitch areas and the light-blocked unit stitch areas are determined by a random number generator, which may be a software program.

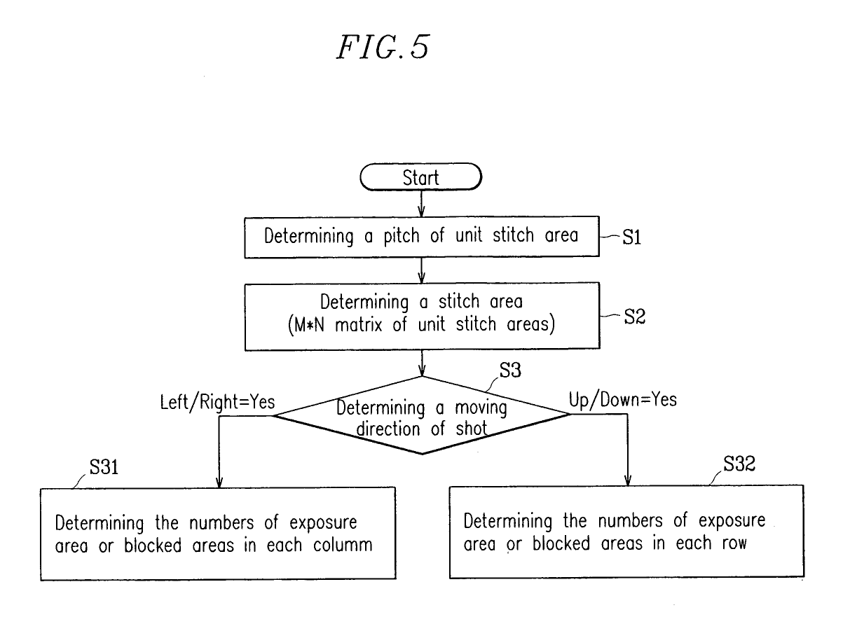

An exemplary method of determining the number of the unit stitch areas and the positions of the light-exposed unit stitch areas and the light-blocked unit stitch areas is described in detail with reference to FIG. 5.

FIG. 5 is a flow chart illustrating a method of determining the number of the unit stitch areas and the positions of the light-exposed unit stitch areas and the light-blocked unit stitch areas according to an embodiment of the present invention.

Referring to FIG. 5, a pitch of the unit stitch areas is determined (S1). In this step, the length and the width of the unit stitch areas are determined. As described above, a unit stitch area may include a pixel area, a plurality of pixel area, or a portion of a pixel area.

Next, a stitch area, which is an overlapping area of adjacent two shots, is determined (S2). The stitch area may include a plurality of unit stitch areas arranged in an N×M matrix or in an M×N matrix where N/M or M/N is a natural number.

Next, a moving direction of shots, for example, a left-right direction or an up-down direction is determined (S3).

When the moving direction of shots is determined to be the left-right direction, the numbers of the light-exposed areas and the light-blocked areas in each column for first and second shots are determined. For the i-th column (where i=1, 2, . . . , M), for example, the number of the light-blocked areas in the first shot is determined to be N−(N/M)×i, while the number of the light-blocked areas in the second shot is determined to be (N/M)×i.

Next, random numbers among one to N for each column and for the first shot is generated by a random number generator. The number of the random numbers is equal to the number of the light-blocked areas or the light-exposed areas determined in the previous step. Then, the positions of the number of the light-blocked areas or the light-exposed areas in the first shot are determined by the generated random numbers. The positions of the number of the light-blocked areas or the light-exposed areas in the second shot are opposite those in the first shot.

When the moving direction of shots is determined to be the up-down direction, the numbers of the light-exposed areas and the light-blocked areas in each row for first and second shots are determined. For the j-th row (where j=1, 2, . . . , N), for example, the number of the light-blocked areas in the first shot is determined to be M−(M/N)×j, while the number of the light-blocked areas in the second shot is determined to be (M/N)×j.

Next, random numbers among one to M for each row and for the first shot is generated by a random number generator. The number of the random numbers is equal to the number of the light-blocked areas or the light-exposed areas determined in the previous step. Then, the positions of the number of the light-blocked areas or the light-exposed areas in the first shot are determined by the generated random numbers. The positions of the number of the light-blocked areas or the light-exposed areas in the second shot are opposite those in the first shot.

If there exist a plurality of stitch areas, the steps S1 to S31 or S32 may be separately performed for each stitch area.

As described above, since the unit stitch areas in a stitch area and the numbers and the positions of the light-blocked areas and the light-exposed areas are determined by using a random number generator, the distribution of the light-exposed areas and the light-blocked areas are uniform, and the numbers and the positions of the light-blocked areas and the light-exposed areas are automatically and statistically determined, thereby increasing averaging effect.

Meanwhile, a plurality of photolithography steps, that is, a plurality of exposures for a plurality of layers are required for forming wires, pixel electrodes, and switching elements of an LCD, especially of an active matrix type LCD (“AMLCD”). In this case, it is required to align the stitch area and the unit stitch areas in the exposure process of the plurality of layers for gradually changing the brightness with accuracy. In addition, stitch areas or unit stitch areas may be differed or the stitch areas for a specific layer(s) may have linear or saw shapes.

As described above, the brightness difference due to stitch errors in an LCD panel is reduced by gradually changing the exposure areas between right and left shots in a divisional exposure process of the LCD panel.

While the present invention has been described in detail with reference to the preferred embodiments, those skilled in the art will appreciate that various modifications and substitutions can be made thereto without departing from the spirit and scope of the present invention as set forth in the appended claims.

1. A method of manufacturing a liquid crystal display panel by a divisional exposure with a plurality of shots including first and second shots adjacent to each other, the method comprising:
preparing a stitch area which is an overlapping area of the first and the second shots at a boundary between the first shot and the second shot and includes a plurality of unit areas, each unit area being light-exposed or light-blocked in the first and the second shots; and
determining the positions or the sizes of the light-exposed unit areas or the light-blocked unit areas by a random number generator, the number of the light-exposed unit areas or the light-blocked unit areas gradually decreasing or increasing along a direction from the first shot to the second shot.

2. The method of claim 1, wherein the determination comprises:
determining a pitch of the unit areas;
determining the stitch area including a plurality of unit areas arranged in an N×M matrix;
determining a moving direction of the first and the second shots;
determining the number of the light-exposed unit areas or the light-blocked unit areas in each row or in each column for the first and the second shots; and
determining positions of the light-exposed unit areas or the light-blocked unit areas in each row or in each column for the first and the second shots using the random number generator.

3. The method of claim 2, wherein N/M or M/N is a natural number.

4. The method of claim 1, wherein the unit area includes a pixel area, a plurality of pixel areas, or a portion of a pixel area.

5. The method of claim 1, wherein the unit area includes a portion of a pixel area and the pixel area is provided with a domain defining member disposed between adjacent unit areas.

6. The method of one of claim 1, wherein the pixel area is defined by intersections of two adjacent gate lines and two adjacent data lines and a boundary line between adjacent unit areas extends parallel to the gate lines.
